(19) United States
(12) Patent Application Publication
(10) Pub. No.: US 2023/0362020 A1
(43) Pub. Date: Nov. 9, 2023

(54) SYSTEMS AND METHODS FOR RECONSTRUCTING AND COMPUTING DYNAMIC PIECEWISE FUNCTIONS ON DISTRIBUTED CONSENSUS SYSTEMS

(71) Applicant: Superluminal Labs Ltd., London (GB)

(72) Inventors: Ariah Aram Klages-Mundt, Winona, MN (US); Steffen SCHULDENZUCKER, Frankfurt am Main (DE)

(21) Appl. No.: 17/738,319

(22) Filed: May 6, 2022

(51) Int. Cl. H04L 9/00; G06F 17/11; G06F 17/15; G06F 17/17

(52) U.S. Cl. CPC H04L 9/50; G06F 17/11; G06F 17/153; G06F 17/175

(57) ABSTRACT

A system for implementing an algorithmic market maker is configured to: receive a transaction including a request to redeem an amount of stablecoins for a reserve asset; retrieve initial states of a current block of a blockchain; determine a region on a curve function associating the stablecoin and the reserve asset, the curve function including at least two regions; determine an anchor reserve value based at least in part on the determined region; and provide a redemption amount of the reserve asset in exchange for the amount of stablecoins in the request based at least in part on the anchor reserve value.

### TECHNICAL FIELD

The present disclosure relates generally to performing computations on peer to peer systems, and more specifically, on systems and methods for reducing computation overhead on solving problems with piecewise functions on blockchain systems.

### BACKGROUND

Mathematical operations and functions are used in computing systems to solve problems in different areas. Some examples of mathematical functions include quadratic functions, linear functions, cubic functions, polynomial functions, signum functions, inverse functions, algebraic functions, trigonometric functions, logarithmic functions, periodic functions, exponential functions, etc. These mathematical functions can be used in different modeling to solve real-world problems. For example, mathematical functions can be used to model and design bridges, computer chips, financial products, wired communication, wireless communication, weather prediction, etc. The use of mathematical functions to describe phenomena as well as make predictions allows the use of computing systems to make calculations.

In some instances, a designer only cares about certain properties of a function or a certain domain and/or range of the function. For example, a cost function for fuel consumed in an automobile versus acceleration of the automobile can be modeled with an exponential curve. But the designer of the automobile knows that the engine is limited so there are certain acceleration values that the automobile will not reach, therefore, the designer can “ignore” or truncate the domain of the exponential cost function, thus simplifying the function for computation. This simplification reduces computational requirements that a computing system calculating the cost function needs to consider. Using the same example, the designer can further simplify the function by doing a piecewise-linear approximation of the exponential cost function in the specific domain of interest. That is, the computational efficiency of evaluating multiple linear functions outweighs any errors that may be introduced by the piecewise-linear approximation.

Piecewise-linear approximation is a technique used in many areas to simplify computation. Piecewise-linear functions are typically easier to handle because linear functions are typically less complicated to evaluate than most other types of functions since piecewise-linear functions have a single independent variable that will at most be compared to determine which linear function to use, and depending on whether the linear function is a constant or has a slope, a multiplication may be performed. Conventional computing systems, for example, servers, laptops, desktops, etc., placed in an environment where trusting a third party is not an issue can evaluate piecewise-linear functions efficiently. But when these conventional computing systems are placed in peer to peer computing environments where consensus paradigms are required for accepting results of computation, performance of computing piecewise-linear functions or dynamic piecewise-linear functions can significantly degrade. The present disclosure provides systems and methods that address drawbacks associated with computing piecewise functions, not just piecewise-linear functions, in peer-to-peer environments (e.g., in blockchain systems).

### SUMMARY

According to some implementations of the present disclosure, a system for implementing an algorithmic market maker is provided. The system includes a non-transitory computer-readable medium storing computer-executable instructions thereon such that when the instructions are executed, the system is configured to: (a) receive a transaction including a request to redeem an amount of stablecoins for a reserve asset; (b) retrieve initial states of a current block of a blockchain; (c) determine a region on a curve function associating the stablecoin and the reserve asset, the curve function including at least two regions; (d) determine an anchor reserve value based at least in part on the determined region; and (e) provide a redemption amount of the reserve asset in exchange for the amount of stablecoins in the request based at least in part on the anchor reserve value.

According to some implementations of the present disclosure, a method for implementing an algorithmic market maker on a blockchain system is provided. The method includes: (a) receiving a transaction including a request to redeem an amount of stablecoins for a reserve asset; (b) retrieving initial states of a current block of a blockchain of the blockchain system; (c) determining a region on a curve function associating the stablecoin and the reserve asset, the curve function including at least two regions; (d) determining an anchor reserve value based at least in part on the determined region; and (e) providing a redemption amount of the reserve asset in exchange for the amount of stablecoins in the request based at least in part on the anchor reserve value.

According to some implementations of the present disclosure, a method for reconstructing and evaluating piecewise linear curves on a discrete distributed system is provided. The discrete distributed system is a peer-to-peer public blockchain system. The method includes: (a) receiving a transaction; (b) retrieving an initial state of a current block of a blockchain of the blockchain system based at least in part on the transaction, the initial state including two or more values of parameters describing specific locations on a curve function; (c) determining a region on the curve function, the curve function including at least two continuous regions, the at least two continuous regions being writable in a piecewise form; (d) determining an anchor value for the determined region, the anchor value indicating at least two dynamic parameters that describe the piecewise form of the determined region; and (e) performing the transaction to determine a next state for a next block of the blockchain based at least in part on the anchor value, the at least two dynamic parameters, and the transaction.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a system for performing computation in a distributed environment, according to some implementations of the present disclosure.

FIG. 2 visualizes examples of reserve ratio curves as a function of stablecoin redemptions for various anchor points, according to some implementations of the present disclosure.

FIG. 3 is a graph for marginal redemption price of a stablecoin modeled as a piecewise-linear function, according to some implementations of the present disclosure.

FIG. 4A is a three dimensional curve of reserve ratio as a function of current redemption amount and initial reserve ratio, according to some implementations of the present disclosure.

FIG. 4B is a two dimensional projection of the three dimensional curve of FIG. 4A on the (x, r) plane.

FIG. 5 is a flow diagram illustrating a process for redeeming an amount of a reserve asset, according to some implementations of the present disclosure.

FIG. 6 is a flow diagram illustrating a process for evaluating piecewise linear curves on a discrete distributed system, according to some implementations of the present disclosure.

The present disclosure is susceptible of various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the disclosure as defined by the appended claims.

### DETAILED DESCRIPTION

As described above in the background section, piecewise functions are typically used to simplify computation, but in peer-to-peer computing systems using consensus paradigms, computation can be inefficient. This is because peer-to-peer computing system include distributed computing systems with at least two of the computing systems not trusting each other. Without trust, consensus algorithms are used to agree on a present state of the peer-to-peer computing system. The consensus algorithm adds an overhead that conventional computing systems do not have to consider. Therefore, embodiments of the present disclosure provide systems and methods for computing piecewise functions on blockchain systems. Because piecewise functions can be applied in different environments as discussed above, the present disclosure will use examples merely for illustration purposes. The use of examples in a blockchain environment or a specific blockchain system does not limit the present disclosure to only such systems. Furthermore, the use of examples in cryptocurrency applications does not limit the present disclosure to only such applications.

Piecewise functions can either be static or dynamic, depending on the application using the piecewise functions. Equations for static piecewise functions can be programmed and/or computed for use. In some implementations, a static piecewise function can be trivial in implementation since the static nature of the piecewise function ensures that the piecewise function does not change as a function of time. As such, once computed, a current mathematical description of the static piecewise function can be used for future calculations. Dynamic piecewise functions are not so and can change as a function of time or some other variable. For example, in dynamic control systems, a system response at a current state of the system can depend on a dynamic piecewise linear function. That is, depending on the state of the system at a specific time, the piecewise linear function describing the behavior of the system can be different. In situations where computing resources are scarce, the different piecewise linear functions may not be stored in the memory of the dynamic control system. In those situations, the dynamic control system may need to reconstruct the appropriate piecewise linear function in order to determine control parameters. In some examples, the control parameters are used to control power supplied to the control system or some other external system, e.g., a signal processing device. Therefore, embodiments of the present disclosure can be applied in systems with limitations on computing, be it limited computing resources (e.g., power, memory, processing speed, etc.) or computing infrastructure that require consensus (e.g., blockchain systems).

Embodiments of the present disclosure improve computation on blockchain systems. An example computational method is provided for implementing region detection on blockchain systems. Embodiments of the present disclosure partition the space of all possible system states into a finite number of regions within which a pricing curve calibration problem is simplified. In some embodiments, the specific region corresponding to a current state is detected. Embodiments of the present disclosure provide computational method for optimizing numerics. Basic arithmetic and a limited number (e.g., one or two) of square root functions are used to reduce computational complexity. Furthermore, several computationally expensive operations can be pre-computed and re-used for subsequent executions. Embodiments of the present disclosure use parameterization to provide systems and methods that do not require manual interventions. Embodiments of the present disclosure use aforementioned systems and methods in a specific example involving reconstructing and computing dynamic piecewise linear functions in a cryptocurrency application.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

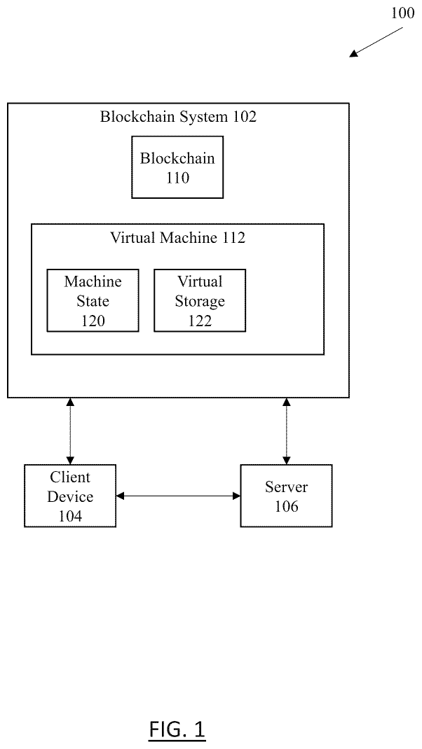

FIG. 1 illustrates a system 100 for performing computation in a distributed environment, according to some implementations of the present disclosure. The system 100 includes a blockchain system 102, a client device 104, and optionally, a server 106. The blockchain system 102 is provided as an example of a distributed peer-to-peer system, but other peer-to-peer systems are envisioned.

The client device 104 is any computing system or computing device used by a user to access services provided by the blockchain system 102 and/or the server 106. In some implementations, the client device 104 is a device used by the user (e.g., a programmer) to write programs to be deployed in the blockchain system 102. In some implementations, the client device 104 is a device used by the user to access resources or initiate transactions on the blockchain system 102. In some implementations, the client device 104 is a device used by the user to access resources provided by the server 106. For example, the client device 104 can access a programming environment (e.g., an integrated development environment) hosted by the server 106. Examples of the client device 104 include a desktop, a laptop, a computer server, a smartphone, a cold wallet, a hot wallet, etc. The server 106 can be a remote server (e.g., a cloud server), a local server, etc. Each of the client device 104 and the server 106 can include one or more processors, memory modules, storage devices, etc., to implement functions described herein.

The blockchain system 102 includes one or more computing devices referred to as nodes. There are different types of nodes, for example, a full node or a partial node. Each node includes at least one processor, at least one memory module, and at least one storage device. The blockchain system 102 functions as a distributed database such that each of the full nodes in the blockchain system 102 includes a full copy of information stored in the distributed database. Accordingly, full nodes tend to emphasize storage requirements over processing requirements. On the other hand, some nodes in the blockchain system 102 can be processor intensive. These processor intensive nodes can be referred to as miners which are incentivized to perform transactions on the blockchain (i.e., blockchain 110). The nodes of the blockchain system 102 are peers in the peer-to-peer computing network. The nodes here are described as physical computing systems underlying the infrastructure of the blockchain system 102.

In some implementations, the blockchain 110 is a public ledger (public database) that is organized as a linked list. Each of the items linked together to form the linked list is called a block. The nodes of the blockchain determine whether or not to add a new block to the linked list (i.e., the blockchain). Since the blockchain 110 is a distributed database, a consensus algorithm is used by the nodes to determine whether the new block should be added to the blockchain 110. In some implementations, a majority of the nodes are required to reach consensus, and in some implementations, all nodes should unanimously approve the new block. The blockchain system 102 uses cryptography and digital signatures to ensure confidentiality and authentication on the blockchain 110. The blockchain system 102 uses hashing to verify information within the blockchain 110 has not been compromised.

In addition to the consensus algorithm, the blockchain system 102 can include other software that underlie the rules of how the blockchain system 102 operates. In some implementations, the blockchain system 102 includes a virtual machine layer (i.e., virtual machine 112) which can provide a virtual machine environment for programmers or developers to build distributed services and/or software for the blockchain 110. The virtual machine 112 includes a machine state 120 and a virtual storage 122. The machine state 120 can be a stack machine that executes one transaction at a time, with each transaction stored in the stack. The machine state 120 maintains a state transition function for the virtual machine 112. The virtual storage 122 is a virtual memory that facilitates performing calculations for determining states of the virtual machine 112. The virtual storage 122 can store smart contracts that have been submitted by the client device 104. A smart contract is a computer program that automatically executes or documents relevant events. The smart contracts can be stored in bytecode. In some implementations, the blockchain system 102 is the Ethereum blockchain and the virtual machine 112 is the Ethereum Virtual Machine.

In some implementations, the server 106 is a cloud server. The cloud server may have a stack that includes a network layer, a data layer, and an application layer. The network layer is responsible for identifying trusted computing systems that are part of the cloud server. The data layer is responsible for data transport and formatting within the cloud server. The application layer is responsible for virtual machine and/or application instantiations. The client device 104 is able to communicate with the server 106, write programs that run on the server 106, and even write smart contracts to be deployed on the blockchain system 102 on the server 106. The server 106 can include storage for storing information remotely, for example, storing smart contracts in a native language (e.g., in solidity). The cloud server is different from the blockchain system 102 in that the blockchain system 102 includes another layer in the stack, a consensus layer. The consensus layer is responsible for consensus algorithm used to determine which nodes in the blockchain system 102 to trust for a specific transaction performed on the blockchain system 102. Furthermore, since transactions must be propagated throughout the blockchain system 102, and in some instances, the number of peers in the blockchain system 102 changes over time, performing continuous computations can be prohibitive. Embodiments of the present disclosure provide systems and methods for alleviating some drawbacks associated with inability to perform continuous computations.

Blockchains are currently used in financial and cryptocurrency applications. Hence, this area will be used as an example. As discussed above, any system that relies upon dynamic piecewise functions with limited computational resources can benefit from aspects of the present disclosure, and stablecoin design is merely used as an example. The design of non-custodial stablecoins has faced several recent turning points, both in the Black Thursday crisis in Dai where Ethereum ETH crashed 50% in one day and in the churn of algorithmic stablecoins. These have both pointed toward the importance of designing good primary markets for stablecoins—i.e., mechanisms for pricing minting and redeeming of stablecoins. There are fundamental problems around deleveraging, liquidity, and scaling in leverage-based stablecoins, like Dai, in which supply depends on an underlying market for leverage.

Black Thursday has motivated a wave of algorithmic stablecoins, which aim to keep the stablecoin supply in line with demand algorithmically. The algorithmic stablecoins can have various degrees of asset backing, including reserve backing. Some algorithmic stablecoins launched have experienced depegging events due to susceptibility to speculative attack and ad hoc primary market structure. In a depegging event, the stablecoin floats with respect to a reference asset. For example, if stablecoin A was pegged to reference asset B at a 1:1 ratio, then if stablecoin A deviates and fluctuates to market conditions regardless of the value of reference asset B, then the stablecoin A is depegged from the reference asset B. In a simplified sense, these peg models are backed by two sources of value: (i) asset backing in a currency reserve and (ii) economic usage, an intangible value that represents the demand to hold the currency as it unlocks access to an underlying economy. Supposing these two values are together great enough, a currency peg is maintainable; otherwise, it is susceptible to breaking. A peg break can also be triggered by a speculative attack that is profitable for the attacker, akin to the attack on the British pound on Black Wednesday.

Algorithmic stablecoins have encountered several fundamental problems, which contribute challenges to strong primary market design. Many have tried to start out under-reserved while having no native economic usage, leading to many observed depeggings through speculative attacks, often exhausting the assets backing the system. Further, the composition of reserve assets that can be held on-chain are inherently risky. In some cases, these assets are non-existent (e.g., Basis). In seigniorage shares-style designs (e.g., Terra and Iron), the backing is effectively the value of “equity shares,” which have an endogenous/circular price with the expected growth of the system. A further type is backed by a portfolio of some mix of exogenous, but risky, assets. Both of these must factor in when formulating a good policy for how the protocol applies reserve assets to maintain liquidity near the peg in sustainable ways. This challenge effectively becomes the problem of designing a primary market for the stablecoin.

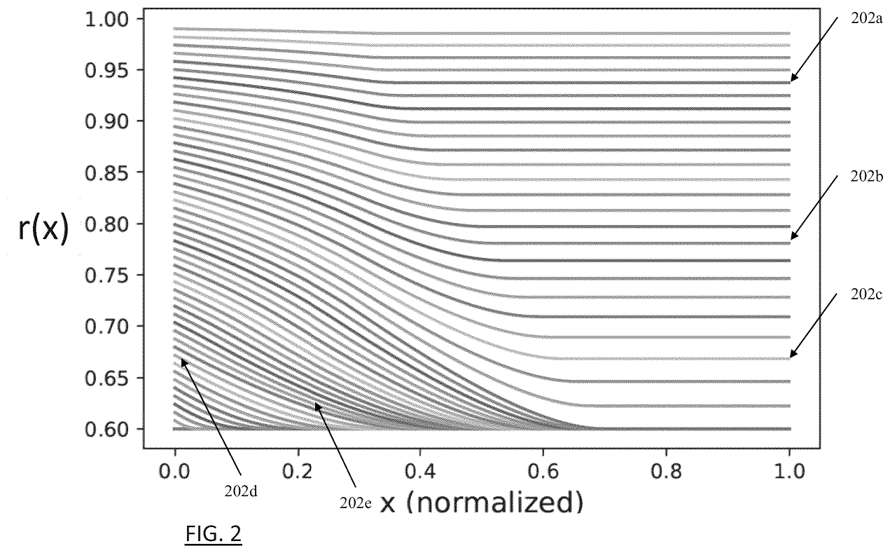

Embodiments of the present disclosure provide a primary algorithmic market maker that prices exchange of assets algorithmically along a curve as a function of reserves and possibly other state variables. In some implementations, one or more of these curves can take on values as depicted in FIG. 2. That is, each of the curves in FIG. 2 illustrates a specific function that can implement a price exchange depending on the reserves of a specific asset. Selecting the right curve in a dynamic system is important to obtaining a desirable exchange rate policy that is also sustainable. In some implementations, for the purposes of designing the primary algorithmic market maker, there are three dimensions to consider: (1) an outstanding stablecoin supply y, a total reserve value backing the stablecoin b, and a level of stablecoin redemptions from the reserve x. These state variables are summarized in the following table.

TABLE 1
Summary of state variables for modeling
the primary algorithmic market maker

| State Variable | Definition |
|---|---|
| b | total reserve value |
| | (e.g., measured in USD) |
| y | outstanding stablecoin supply |
| | (e.g., measured in a stablecoin unit) |
| x | level of stablecoin redemptions |
| | (e.g., measured in the stablecoin unit) |

The primary algorithmic market maker can be modeled as a dynamical system, in which x is the independent variable that drives the primary algorithmic market maker. That is, x represents the “current point along the trading path” of the primary algorithmic market maker. Furthermore, a reserve ratio can be determined. The reserve ratio is defined as r(x):=b(x)/y(x), which describes the reserve value per outstanding stablecoin. b, y, x and r refer to the “current” state of these variables, while b(x), y(x), and r(x) refer to the value of these variables at some point of the driving variable x and based on other system parameters.

Blockchain transactions occur within blocks. Thus, the primary algorithmic market maker trades are modeled as occurring within a single block. At the beginning of the block, initial conditions (x₀, b₀, y₀) are present. Here, x₀ represents a measure of redemption history in previous blocks. Net redemptions within the modeled block will increase x from x₀. The values of the variables will evolve over many blocks using this same intra-block model; however, x₀ at the start of each block will be computed as an exponentially time-discounted sum over all past stablecoin redemptions in previous blocks. Using a single block for analysis, x₀ is a fixed initial condition. The initial conditions are summarized in the following table.

TABLE 2
Summary of initial conditions for the state variables
for modeling the primary algorithmic market maker

| Initial Condition | Definition |
|---|---|
| x₀ | level of stablecoin redemptions |
| | at the start of the block |
| b₀ | reserve value at start of the |
| | current block (b₀ = b(x₀) |
| y₀ | outstanding stablecoin supply at the |
| | start of the block (y₀ = y(x₀)) |

Although x₀ in a given block will be computed as an exponential time-discounted sum of redemptions in past blocks, it is useful to reference a fictitious initial condition that would describe a starting point of x₀ equals 0. This fictitious initial condition is called the anchor point, formally provided as the triplet (0, bₐ, yₐ). bₐ=b(0) and yₐ=y(0). The subscript a when used throughout will refer to values evaluated at the anchor point. The reserve ratio at the anchor point rₐ=bₐ/yₐ. FIG. 2 visualizes examples of what the reserve ratio curves (e.g., curves 202a, 202b, 202c, 202d, and 202e) will look like as a function of x for various values of rₐ. Each curve will have a unique anchor point rₐ, which corresponds to the starting point of the curve. For example, curve 202a has an rₐ of about 0.96, curve 202b has an rₐ of about 0.87, curve 202c has an rₐ of about 0.83, curve 202d has an rₐ of about 0.67, and curve 202e has an rₐ of about 0.69.

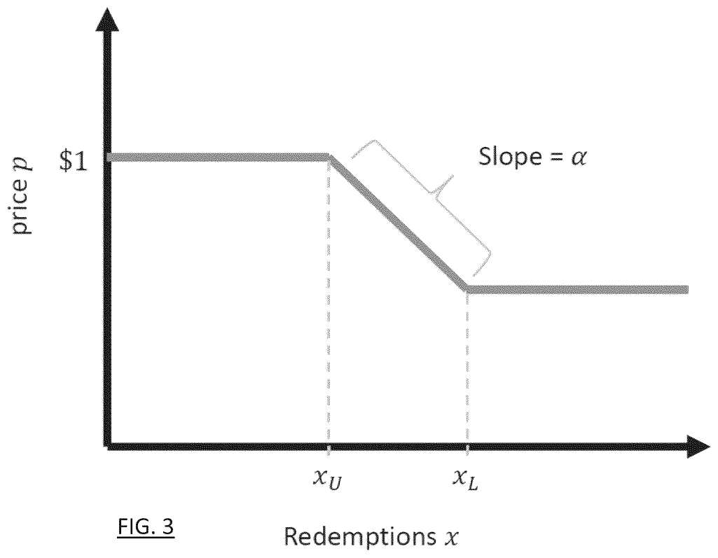

To visualize the block by block calculation, let (x₀, b₀, y₀) be the state at the beginning of a block. Consider a situation where x₀=0, i.e., no redemptions have been made yet. In one example curve, the primary algorithmic market maker can be set up such that the marginal redemption price p of the stablecoin follows a piecewise-linear curve depicted in FIG. 3. In FIG. 3, p=1 USD up until a point x_{U}, then decreases linearly with a slope α and finally, at a point x_{L}, becomes constant again. To compute the amount of USD that a given amount X of the stablecoin can be redeemed for, one computes the integral from 0 to X over the price curve of FIG. 3.

Now consider the situation where x₀>0. Then we choose the anchor point (bₐ, yₐ) such that the initial condition (b₀, y₀, x₀) would arise from the point (bₐ, yₐ, 0) by a redemption of size x₀ according to the above process. The point (bₐ, yₐ) is well-defined. Computing yₐ is straightforward because we must have yₐ=y₀+x₀, but computing bₐ is not. To perform a redemption, integrate along the price curve of FIG. 3, this time from x₀ to x₀+X.

A redemption increases the redemption level from x₀ to x₀+X. At the same time, when time passes without redemptions, the redemption level decreases by itself. Note that the anchor point is “virtual” in the sense that the primary algorithmic market maker may never have been at the state (bₐ, yₐ, 0). Instead, it is a useful accounting tool that provides a point of comparison for movements in the primary algorithmic market maker that changes with outflows/inflows, decay of the outflow measure, and the reserve value. FIG. 3 is parameterized as follows in Table 3.

TABLE 3
Dynamic parameters of the Piecewise-linear redemption curve

| Dynamic Parameter | Definition |
|---|---|
| α | decay slope of the redemption curve |
| x_{U} | point at which redemption curve deviates |
| | from price p = 1 USD redemption |
| x_{L} | point at which redemption curve |
| | stops decaying at new reserve ratio |

The pricing curve, as a function of x and parameterized by the anchor point is provided as follows when bₐ<yₐ.

$$p ( x ; {b}_{a} , {y}_{a} ) = \{ \begin{matrix}1 , & x \leq {x}_{U} \\ 1 - α ( x - {x}_{U} ) , & {x}_{U} \leq x \leq {x}_{L} \\ {r}_{L} & x \geq {x}_{L}\end{matrix} \qquad ( 1 )$$

In the equation above, r_{L}=r(x_{L}). In the other case that bₐ≥yₐ, p(x)=1. Notice that the dynamic parameters of Table 3 are functions of the anchor point (bₐ, yₐ) and the following static parameters of Table 4 that constrain the shape of the curve of FIG. 3.

TABLE 4
Static parameters of the piecewise-linear redemption curve

| Dynamic Parameter | Definition |
|---|---|
| α̅ | ∈ [0, ∞] lower bound on decay slope (α ≥ α̅) |
| x̅_{U} | ∈ [0, ∞] upper bound on x_{U} (x_{U} ≤ x̅_{U}) |
| θ̅ | ∈ [0, 1] target reserve ratio floor |

The static parameters can be set externally for specific problems. In Table 4, a lower bound α̅ is defined for the linear decay slope α, an upper bound x̅_{U} is defined for x_{U}, and a target reserve ratio floor θ̅ is the minimum reserve ratio that the redemption curve of FIG. 3 can decay to. In the case where the initial reserve ratio b₀/y₀ is smaller than θ̅, then redemptions are offered at the initial reserve ratio (i.e., x_{L}=0). There is an implicit fourth static parameter, i.e., the target for the stablecoin price, thus far assumed to be p=1 USD. In general, this fourth parameter can take different values (and can be changed over time by governance in the blockchain system 102) to adjust monetary policy. The underlying mechanics described thus far would not be affected by changing the target for the stablecoin price.

The static parameters of the Table 4 can be set arbitrarily without affecting the underlying mechanics described thus far, so long as the static parameters are fixed. Embodiments of the present disclosure provide that the pricing curve p is parameterized by the anchor point and is, in general, a function of bₐ and yₐ. This expression allows the anchor point to be determined based on the current state alone. Keeping this in mind, it is analytically useful to define evolution of the dynamical system in terms of the current state (x, b, y) directly.

If p is the marginal redemption price and r:=b/y is the reserve ratio, the blockchain system 102 will choose dynamic parameters such that p≥r≥θ̅ for all states on the redemption curve of FIG. 3, unless this constraint is impossible due to an external shock to the reserve. If r₀:=b₀/y₀<θ̅, then the condition regarding θ̅ is unachievable and redemption will always occur at the constant price r₀, so that the redemption amount is r₀·X. Therefore, assume that r₀ is at least θ̅. The dynamic parameters can be chosen according to the following rules:

Firstly, x_{L} is defined as the point where p=r (i.e., at x_{L}, the computed redemption price equals the reserve ratio). If x_{L} is chosen according to this constraint, then all remaining stablecoins can be redeemed at this price without running out of reserves. x_{L} can be computed from (bₐ, yₐ), x_{U}, and α. Note that r(x_{L}) is the lowest reserve ratio on the curve of FIG. 3. One can show that r(x_{L}) increases when α is increased (i.e., the reserve is protected when redemption prices decay more steeply) and when x_{U} is decreased (i.e., the reserve is protected when the redemption price starts to decay earlier).

Secondly, α and x_{U} are chosen to guarantee that r(x_{L})≥θ̅ while minimizing price decay.

Thirdly, α is prioritized to be as small as possible, but still being at least α̅ (i.e., making price decay as mild as possible in the linear part). If α=α̅, then x_{U} is chosen to be as large as possible (but at most x̅_{U}), while always ensuring that r(x_{L})≥θ̅.

These three rules lead to the following equations:

$$α = max ( \overline{α} , \hat{α} ) , where \hat{α} = \{ \begin{matrix}{\hat{α}}_{H} := 2 \frac{( 1 - {r}_{a} )}{{y}_{a}} , & {r}_{a} \geq \frac{1 + \overline{θ}}{2} \\ {\hat{α}}_{L} := \frac{1}{2} \frac{{θ}^{2}}{{b}_{a} - θ {y}_{a}} , & {r}_{a} \leq \frac{1 + \overline{θ}}{2}\end{matrix} \qquad ( 2 )$$

$${x}_{U} = min ( {\overline{x}}_{U} , {\hat{x}}_{U} ) , where {\hat{x}}_{U} = \{ \begin{matrix}{\hat{x}}_{U , h} := {y}_{a} - \sqrt{2 \frac{Δ a}{α}} , & {αΔ}_{a} \leq \frac{1}{2} {θ}^{2} \\ {\hat{x}}_{U , l} := {y}_{a} - \frac{Δ a}{θ} - \frac{1}{2 α} θ , & {αΔ}_{a} \geq \frac{1}{2} {θ}^{2}\end{matrix} \qquad ( 3 )$$

$${x}_{L} = {y}_{a} - \sqrt{{( {y}_{a} - {x}_{U} )}^{2} - \frac{2}{α} ( {y}_{a} - {b}_{a} )} \qquad ( 4 )$$

$${r}_{L} = 1 - α ( {x}_{L} - {x}_{U} ) \qquad ( 5 )$$

Here, rₐ:=bₐ/yₐ and Δₐ=yₐ−bₐ

With the redemption curve parameters determined using the above rules and static parameters, outflow tracking can be accomplished by the blockchain system 102. The outflow value xo tracks a block-discounted exponential moving sum of all outflows from the reserve. In some implementations, a parameter δ is provided as a discount factor. δ is a number that is greater than or equal to 0 but less than 1. Assume that the current block number in the blockchain 110 is T and for each past block t≤T, assume that an amount of Xₜ of the stablecoin was redeemed in each block t since the beginning of time. Let X_{T} be the amount of redemption performed so far in the current block. Then

$${x}_{0} = {\sum }_{t \leq T} {δ}^{T - t} {X}_{t} .$$

Although x₀ is written as a summation that takes into account redemptions from previous blocks, embodiments of the present disclosure do not need to store the past redemption amounts Xₜ. The current value of x₀ and the block number in which x₀ was last updated is all that needs to be stored. Specifically, if x′₀ is the value of x₀ at some previous transaction that took place in the block T′≤T, then the value of x₀ at the beginning of the current transaction in block T is

x₀=δ^{T-T′}x′₀.

This expression of x₀ is correct whether this is the first redemption transaction in a block or not (i.e., whether T′<T or T′=T).

Referring back to the rules and the parameters, different cases can be obtained. Case I-III depend on the values of α and x_{U}. Specifically, Case I is defined as the case where \acute{α}≥α̅ and x̅_{U}≥\hat{x}_{U}, so that α=α̅ and x_{U}=x̅_{U}. Case II is defined as the case where \hat{α}≥α̅ and x̅_{U}≤\hat{x}_{U}, so that α=α̅ and x_{U}<x̅_{U}, except in the equality case. Case III is defined as the case where \hat{α}≤α̅, so that α<α̅ except in the equality case and (in any case) x_{U}=0.

Furthermore, Case H can be defined where

$${r}_{a} \geq \frac{1 + \overline{θ}}{2}$$

and thus \hat{α}=\hat{α}_{H}. Similarly, Case L can be defined where

$${r}_{a} \leq \frac{1 + \overline{θ}}{2}$$

and thus \hat{α}=\hat{α}_{L}.

Furthermore, Case h can be defined where

$$α {Δ}_{a} \leq \frac{1}{2} {θ}^{2}$$

and thus \hat{x}_{U}=\hat{x}_{U,h}. Similarly, Case 1 can be defined where

$$α {Δ}_{a} \geq \frac{1}{2} {θ}^{2}$$

and thus \hat{x}_{U}=\hat{x}_{U,l}.

Furthermore, depending on the value of x relative to x_{U} and x_{L}, Case i can be defined as x≤x_{U}. Similarly, Case ii can be defined as x_{U}≤x≤x_{L}. Similarly, Case iii can be defined as x_{L}≤x.

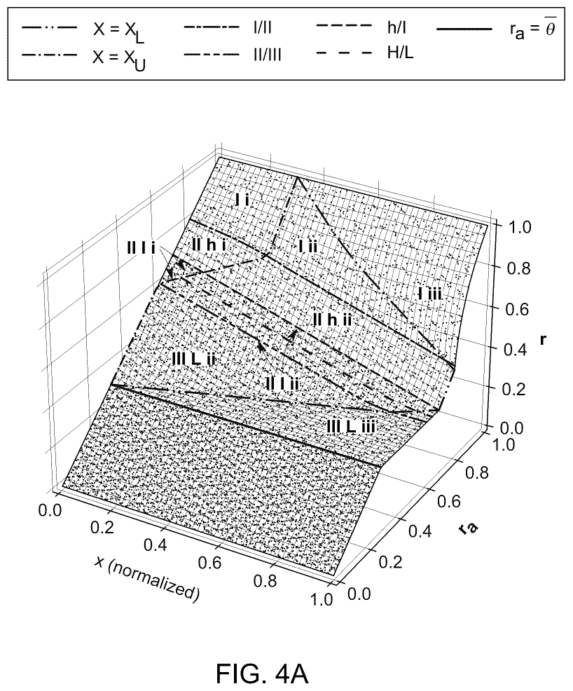

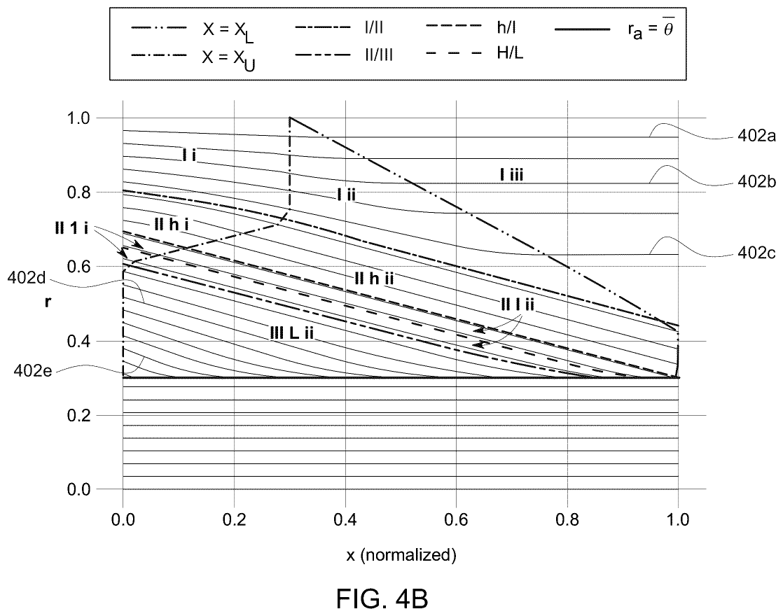

By obtaining these different cases, the space of all possible (bₐ, x) pairs can be segmented into a certain number of regions within which b, as a function of bₐ and x, is smooth. When this process is performed, the space is found to be a polynomial in bₐ of degree of at most 2. FIG. 4A illustrates an example three dimensional view of the function and the different regions as defined by the cases above. FIG. 4A illustrates the reserve ratio r as a function of the current redemption amount x and the initial reserve ratio rₐ for the normalized case yₐ=1, labeled with the different regions corresponding to a combination of the different cases defined above. Due to normalization, in FIG. 4A, rₐ=bₐ. The static parameters θ̅=0.3, α̅=0.5, and x̅_{U}=0.3 were used to determine the three dimensional curve of FIG. 4A. The static parameter values are merely used as examples, and choosing other values for the static parameters can yield different shapes. For example, if θ̅ were chosen to be 0.2, the unlabeled surface would have a smaller area. FIG. 4B illustrates a two dimensional projection of the curve of FIG. 4A to the (x, r) plane. In FIG. 4B, example curve projections (e.g., curve 402a, 402b, 402c, 402d, and 402e) relating x and r are highlighted. The different regions (e.g., {I, i}, {I, ii}, {II, h, ii}, etc.) are also highlighted in FIG. 4B. The unlabeled region shows curve projections of r unchanging with x.

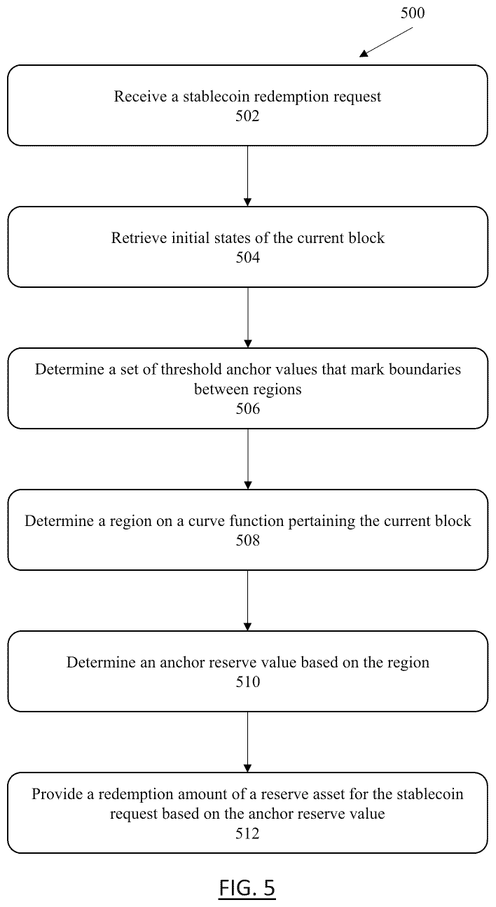

FIG. 5 is a flow diagram illustrating a process 500 for redeeming an amount of a reserve asset, according to some implementations of the present disclosure. The process 500 is performed by the blockchain system 102. The blockchain system 102 includes a smart contract in the virtual storage 122 that provides steps for implementing the process 500. At 502, the blockchain system 102 receives a stablecoin redemption request (i.e., the blockchain system 102 receives a transaction to redeem a stablecoin). The stablecoin redemption request includes an amount of a stablecoin to be exchanged for a reserve asset. For example, the stablecoin redemption request can include exchanging X stablecoins for reserve asset in USD. The stablecoin redemption request may originate from the client device 104. The stablecoin redemption request may originate from a smart contract stored on the server 106. In some implementations, the stablecoin redemption request may originate from a smart contract stored in the virtual storage 122. For example, the smart contract stored in the virtual storage 122 may realize that a certain condition is reached for exchanging the X stablecoins for the reserve asset and proceeds to automatically initiate the transaction.

At 504, the blockchain system 102 retrieves initial states of the current block. The blockchain 110 stores accounts and other information for the blockchain system 102. In some implementations, the initial states of the current block are stored in the accounts associated with the smart contract that implements the process 500. In some implementations, the initial states of the current block are stored in the blockchain 110. The current block has a block number associated with it. To keep nomenclature, the current block is indicated here as T. The initial states of the current block T may be provided as (b₀, y₀, x₀). That is, the initial states of the current block T include total reserve value at the start of the current block T, a level of stablecoin redemptions at the start of the current block T, and an outstanding stablecoin supply at the start of the current block T. Note that total reserve value at the start of the current block T and outstanding stablecoin supply at the start of the current block T can be affected by minting of additional stablecoins and re-evaluation of the reserve value.

At 506, the blockchain system 102 determines a set of threshold anchor values bₐ′ that mark boundaries between regions. The threshold anchor values depend on the static parameters θ̅, α̅, and x̅_{U}.

In some implementations, since the threshold anchor values bₐ′ do not depend on the current state of the blockchain system 102, these threshold anchor values bₐ′ can be precomputed and stored on the blockchain 112. In some implementations, the difference between computing the threshold anchor values bₐ′ and reading the threshold anchor values bₐ′ from the blockchain 112 is negligible because reading the threshold anchor values bₐ′ may not produce any significant advantage in terms of gas fees needed to incentivize nodes of the blockchain 112 to perform either task.

At 508, the blockchain system 102 determines a region on a curve function pertaining to the current block T. The blockchain system 102 compares the current reserve value b₀ that would arise at x=x₀ for each threshold anchor value in the set of threshold anchor values bₐ′ obtained at 506. By exploiting some monotonicity properties, Case I, II, or III are determined. Then Case H/L, or h/l is determined. Additional analytic properties are exploited to detect Case i, ii, or iii. Determining the different cases in this order allows narrowing down the region on the curve function such that the region can be described as a combination of {Case I, II, or III; Case H or h; Case i, ii, or iii}. In some implementations, the curve function may have regions that are independent of Case H or h as depicted in FIG. 4A.

At 510, the blockchain system 102 determines an anchor reserve value bₐ for the specific region determined at 508. The anchor reserve value bₐ is a fictitious computational tool that allows determining a shape of the curve (e.g., shape of curve 202b of FIG. 2 vs. curve 202c of FIG. 2). In some implementations, the shape is a localized shape of the curve (e.g., curve 402c of FIG. 4B approximating a contour of the curve function of FIG. 4A). In some implementations, assuming that the anchor reserve value bₐ, is known, the reserve value b(x) at any given redemption level x is provided as:

$$b ( x ) = {b}_{a} - {\int }_{0}^{x} p ( {x}^{′} ) {dx}^{′} = \{ \begin{matrix}{b}_{a} - x , & x \leq {x}_{U} \\ {b}_{a} - x + \frac{α}{2} {( x - {x}_{U} )}^{2} , & {x}_{U} \leq x \leq {x}_{L} , \\ {r}_{L} ( {y}_{a} - x ) & x \geq {x}_{L}\end{matrix}$$

Within any known region, the dynamic parameters α and x_{U} and (by extension) x_{L} can be written as a smooth expression in the anchor reserve value bₐ. x₀ can be plugged into the reserve value b(x) equation to solve for the anchor reserve value bₐ. That is, the equation b(x₀; bₐ)=b₀ can be solved for bₐ. Some instances of solving this equation are trivial and can be excluded (e.g., bₐ=b₀+x₀ in Case i and r₀≤θ̅ in {Case II, case iii} and {Case III, case iii}). Therefore, once bₐ is known for a specific region, then the dynamic parameters α, x_{U}, and x_{L} are determined, using for example, equations 2-5 above. Note that normalization rules of FIG. 4A where rₐ=bₐ can be beneficial in reducing complexity of determining the dynamic parameters.

The determination of the anchor reserve value bₐ enables determining the structure of the piecewise linear function (i.e., the positions and slopes of the linear segments) for specific blocks. For the purposes of computation, the initial states of the current block obtained at 504 (e.g., (b₀, y₀, x₀)) are assumed to have evolved from the anchor point (i.e., (bₐ, yₐ, 0)). Determining the anchor reserve value bₐ enables determining the dynamic parameters α, x_{U}, and x_{L} that describe the piecewise linear function (e.g., FIG. 3) that would approximate a specific one of the curves of FIG. 2 (e.g., the curve 202c). As such, the initial states of the current block (b₀, y₀, x₀) can be used to reconstruct the piecewise linear function without independently knowing the anchor point. The anchor point is determined from the initial states. Once the piecewise linear function is reconstructed, parameters associated with the piecewise linear function can be used in further calculations.

At 512, the blockchain system 102 provides a redemption amount B of the reserve asset for the stablecoin redemption request based on the determined anchor reserve value bₐ obtained at 510. The anchor reserve value bₐ at 510, the X stablecoins in the redemption request at 502, and the level of stablecoin redemptions at the start of the current block x₀ can be used in the reserve value b(x) equation above to determine the redemption amount B. The redemption amount B paid out when redeeming X stablecoins is determined as B:=b(x₀+X)−b(x₀).

Embodiments of the present disclosure provide systems and methods for implementing a primary algorithmic market maker with various advantages. For example, within a block, the relative collaterization (i.e., the reserve ratio) of the primary algorithmic market maker is guaranteed to stay above the lower bound θ̅, unless an exogenous shock hits the reserve assets. That is, the worst-case redemption rate is lower-bounded. For another advantage, the primary algorithmic market maker normally maintains a region of open market operations in which the stablecoin price is pegged to the reserve asset price (i.e., the section of the curve of FIG. 3 where redemptions x is less than or equal to x_{U}. For another advantage, the redemption curve can be continuous and not steep. For another advantage, there is no incentive provided for redeemers to strategically subdivide redemptions. That is, the primary algorithmic market maker provides path independence or path deficiency.

The primary algorithmic market maker ensures that the reserve can only be exhausted over a long time period. Furthermore, over many blocks, a depegged stablecoin has a path toward regaining the peg. The primary algorithmic market maker can be efficiently implemented and computed on-chain. Furthermore, traders with no urgent need to redeem and who believe the value of the reserve will not permanently decrease for exogenous reasons are incentivized to delay redemptions to a time of low outflows from the reserve.

The primary algorithmic market maker can be implemented on-chain under tight resource constraints. Embodiments of the present disclosure can provide high numerical precision. That is, the accuracy of the primary algorithmic market maker is only limited by the accuracy of the underlying implementation of numerical operations. Embodiments of the present disclosure have reduced communication overhead. The primary algorithmic market maker can react to changing market conditions autonomously without any intervention from the outside world. This reduces relatively costly input from the outside world and improves reaction time compared to conventional approaches.

Embodiments of the present disclosure provide a primary algorithmic market maker with high computational efficiency. Fixed-point arithmetic using only basic numerical operations and a limited number (i.e., one or potentially two) of square root operations per execution are used in some implementations. Furthermore, a limited amount of data is stored during operation, thus helping reduce storage costs.

The aforementioned advantages are important in limited computational environments, especially blockchain systems. Blockchain systems have limited numerical capabilities. Blockchain systems do not typically have built-in floating-point capabilities and no mathematical co-processor. Furthermore, off-the-shelf floating-point implementations are impractical due to limited accuracy anyways. Instead, basic fixed-point math operations are implemented using basic integer arithmetic only in blockchains. Furthermore, blockchain systems have high computational cost. Compared to a regular computer, in a blockchain system, each individual operation is extraordinarily costly, with users needing to pay compensation per-operation using native tokens or other tokens on the blockchain system. Data storage is subject to similar constraints. Blockchain systems do not have a continuous operation. Blockchain systems pause and run in discrete intervals that the blockchain system itself cannot control. There is no way of running part of the blockchain system continuously “in the background” as with regular computers. Furthermore, blockchain systems rely on decentralized governance where modules are not usually controlled by a single party but by a large number of actors via a voting mechanism. This makes manual interventions relatively costly, computationally expensive, and time-consuming. Manual interventions also imply risk (e.g., these interventions may be malicious). For at least these reasons, existing computational techniques (e.g., iterative techniques or simulation approaches) are infeasible on blockchain systems.

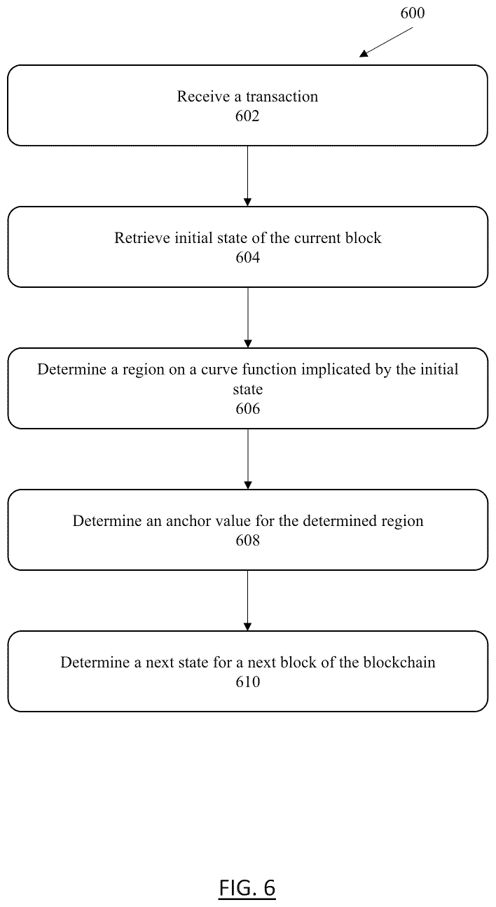

FIG. 6 is a flow diagram illustrating a process 600 for evaluating piecewise linear curves on a discrete distributed system (e.g., the blockchain system 102), according to some implementations of the present disclosure. At 602, the blockchain system 102 receives a transaction. The transaction can be received from the client device 104, from the server 106, and/or from a stack of queued transactions provided in the virtual storage 122.

At 604, the blockchain system 102 retrieves an initial state of a current block of the blockchain 110 of the blockchain system 102 based at least in part on the received transaction. The initial state includes two or more values of parameters describing specific locations on a curve function. For example, referring to 504 of FIG. 5, the blockchain system retrieves the initial state of the current block T provided as (b₀, y₀, x₀). The initial state can exist on one of many piecewise linear curves (e.g., the curves provided in FIG. 2). The initial state obtained does not provide which one of the curves. The blockchain system 102 only knows that the initial state resides on the curve function.

At 606, the blockchain system 102 determines a region on the curve function. The curve function includes at least two continuous regions. The at least two continuous regions are writable in a piecewise form. For example, the annotated curve function shown in FIGS. 4A and 4B have labeled contiguous regions with highlighted boundaries between these contiguous regions.

At 608, determining an anchor value for the determined region. The anchor value indicates at least two dynamic parameters that describe the piecewise form of the determined region. For example, if the piecewise linear form is described as a function exhibiting two flat portions and a sloped portion as indicated in FIG. 3, then the anchor value helps identify a specific one of the curves (e.g., one of the r(x) curves in FIG. 2). The specific one of the curves allows expressing an equation that can be used to evaluate the transaction.

At 610, the blockchain system 102 performs the transaction to determine a next state for a next block of the blockchain 110 based at least in part on the anchor value, the at least two dynamic parameters, and the transaction. Depending on contents of the transaction, the blockchain system 102 performing the transaction can involve moving along the specific identified curve. For example, at 512 of FIG. 5, a redemption transaction may result in reducing the reserve amount so that a next state of the blockchain 110 has a reserve price that is different from the reserve price of the initial state of the blockchain 110.

Embodiments of the present disclosure include various steps and operations, which have been described above. A variety of these steps and operations may be performed by hardware components or may be embodied in machine-executable instructions, which may be used to cause one or more general-purpose or special-purpose processors programmed with the instructions to perform the steps. Alternatively, the steps may be performed by a combination of hardware, software, and/or firmware.

Embodiments of the techniques introduced here may be provided as a computer program product, which may include a machine-readable medium having stored thereon non-transitory instructions which may be used to program a computer or other electronic device to perform some or all of the operations described herein. The machine-readable medium may include, but is not limited to optical disks, compact disc read-only memories (CD-ROMs), magneto-optical disks, floppy disks, ROMs, random access memories (RAMs), erasable programmable read-only memories (EPROMs), electrically erasable programmable read-only memories (EEPROMs), magnetic or optical cards, flash memory, or other type of machine-readable medium suitable for storing electronic instructions. Moreover, embodiments of the present disclosure may also be downloaded as a computer program product, wherein the program may be transferred from a remote computer to a requesting computer by way of data signals embodied in a carrier wave or other propagation medium via a communication link.

The phrases “in some embodiments,” “according to some embodiments,” “in the embodiments shown,” “in other embodiments,” “in some examples,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting the scope of the disclosure, which is defined by the claims.

What is claimed is:

1. A system for implementing an algorithmic market maker, the system including a non-transitory computer-readable medium storing computer-executable instructions thereon such that when the instructions are executed, the system is configured to:
receive a transaction including a request to redeem an amount of stablecoins for a reserve asset;
retrieve initial states of a current block of a blockchain;
determine a region on a curve function associating the stablecoin and the reserve asset, the curve function including at least two regions;
determine an anchor reserve value based at least in part on the determined region; and
provide a redemption amount of the reserve asset in exchange for the amount of stablecoins in the request based at least in part on the anchor reserve value.

2. The system of claim 1, wherein the curve function is a three-dimensional curve function or a two-dimensional curve function.

3. The system of claim 1, wherein the initial states of the current block of the blockchain include a total reserve value of the reserve asset at the start of the current block, an outstanding supply of the stablecoins at the start of the current block, and a level of stablecoin redemptions at the start of the current block.

4. The system of claim 3, wherein the total reserve value of the reserve asset at the start of the current block is based at least in part on re-valuation of the reserve asset and the outstanding stablecoin supply at the start of the current block is based at least in part on minting of the stablecoin.

5. The system of claim 1, wherein the at least two regions are continuous, having a piecewise relationship.

6. The system of claim 5, further configured to:
determine dynamic parameters based on the determined anchor reserve value, the dynamic parameters describing a localized shape of the curve function, the dynamic parameters including a decay slope, a point where the curve deviates from a pegged value, and a point where the curve stops decaying.

7. The system of claim 6, wherein the decay slope has fixed a lower bound.

8. The system of claim 6, wherein the point where the curve deviates from the pegged value has an upper bound.

9. The system of claim 5, wherein each of the at least two regions has different boundaries that depend on a selection of static parameters.

10. A method for implementing an algorithmic market maker on a blockchain system, the method comprising:
receiving a transaction including a request to redeem an amount of stablecoins for a reserve asset;
retrieving initial states of a current block of a blockchain of the blockchain system;
determining a region on a curve function associating the stablecoin and the reserve asset, the curve function including at least two regions;
determining an anchor reserve value based at least in part on the determined region; and
providing a redemption amount of the reserve asset in exchange for the amount of stablecoins in the request based at least in part on the anchor reserve value.

11. The method of claim 10, wherein the curve function is a three-dimensional curve function or a two-dimensional curve function.

12. The method of claim 10, wherein the initial states of the current block of the blockchain include a total reserve value of the reserve asset at the start of the current block, an outstanding supply of the stablecoins at the start of the current block, and a level of stablecoin redemptions at the start of the current block.

13. The method of claim 12, wherein the total reserve value of the reserve asset at the start of the current block is based at least in part on re-valuation of the reserve asset and the outstanding stablecoin supply at the start of the current block is based at least in part on minting of the stablecoin.

14. The method of claim 10, wherein the at least two regions are continuous, having a piecewise relationship.

15. The method of claim 14, further comprising:
determining dynamic parameters based on the determined anchor reserve value, the dynamic parameters describing a localized shape of the curve function, the dynamic parameters including a decay slope, a point where the curve deviates from a pegged value, and a point where the curve stops decaying.

16. The method of claim 15, wherein the decay slope has fixed a lower bound.

17. The method of claim 15, wherein the point where the curve deviates from the pegged value has an upper bound.

18. The method of claim 14, wherein each of the at least two regions has different boundaries that depend on a selection of static parameters.

19. A method for reconstructing and evaluating piecewise linear curves on a discrete distributed system, the discrete distributed system being a peer-to-peer public blockchain system, the method comprising:
receiving a transaction;
retrieving an initial state of a current block of a blockchain of the blockchain system based at least in part on the transaction, the initial state including two or more values of parameters describing specific locations on a curve function;
determining a region on the curve function, the curve function including at least two continuous regions, the at least two continuous regions being writable in a piecewise form;
determining an anchor value for the determined region, the anchor value indicating at least two dynamic parameters that describe the piecewise form of the determined region; and
performing the transaction to determine a next state for a next block of the blockchain based at least in part on the anchor value, the at least two dynamic parameters, and the transaction.

20. The method of claim 19, wherein the performing the transaction changes at least one of the two or more values of parameters describing specific locations on the curve function.
